(19) United States
(12) Patent Application Publication
(10) Pub. No.: US 2026/0209058 A1
(43) Pub. Date: Jul. 23, 2026

(54) METHOD FOR MANUFACTURING ALUMINUM HYDROXIDE

(71) Applicants: Eiji TABATA, Nisshin-shi (JP); Yuichi FURUKAWA, Toyota-shi (JP); Takeshi SAKURAGI, Toyota-shi (JP); Yuki UCHIDA, Nagoya-shi (JP); Rintaro TOYAMA, Nagoya-shi (JP); Ryosaku TSUTSUI, Tahara-shi (JP); Sawako KAWAHARA, Nagoya-shi (JP); Makoto SHIOZAKI, Toyota-shi (JP)

(72) Inventors: Eiji TABATA, Nisshin-shi (JP); Yuichi FURUKAWA, Toyota-shi (JP); Takeshi SAKURAGI, Toyota-shi (JP); Yuki UCHIDA, Nagoya-shi (JP); Rintaro TOYAMA, Nagoya-shi (JP); Ryosaku TSUTSUI, Tahara-shi (JP); Sawako KAWAHARA, Nagoya-shi (JP); Makoto SHIOZAKI, Toyota-shi (JP)

(73) Assignees: TOYOTA JIDOSHA KABUSHIKI KAISHA, Toyota-shi, (JP); MEC International Co., Ltd., Toyota-shi (JP)

(21) Appl. No.: 19/438,881

(22) Filed: Jan. 2, 2026

(30) Foreign Application Priority Data
Jan. 23, 2025 (JP) 2025-009922

(51) Int. Cl. C01F 7/34

(52) U.S. Cl. CPC C01F 7/34; C01P 2006/80

(57) ABSTRACT

A method for manufacturing aluminum hydroxide includes: a first neutralization process of adding, to a crude alkaline aluminate solution, an amount of substance of a first acid which neutralizes a part of alkali metal aluminate in the crude alkaline aluminate solution, thereby precipitating a precipitation containing aluminum hydroxide and impurities; a solid-liquid separation process of performing solid-liquid separation on a neutralization treatment solution obtained by the neutralization, thereby obtaining a purified alkaline aluminate solution from which the precipitation precipitated has been removed; a second neutralization process of adding, to the purified alkaline aluminate solution obtained, a neutralization equivalent or more of a second acid which neutralizes a remainder of the alkali metal aluminate in the purified alkaline aluminate solution, thereby precipitating aluminum hydroxide; and an aluminum hydroxide recovery process of recovering the aluminum hydroxide precipitated.

### CROSS REFERENCE TO RELATED APPLICATIONS

This application is based upon and claims the benefit of priority from Japanese patent application No. 2025-009922, filed on Jan. 23, 2025, the disclosure of which is incorporated herein in its entirety by reference.

### BACKGROUND

The present disclosure relates to a method for manufacturing aluminum hydroxide.

In general, Aluminum hydroxide is manufactured by a manufacturing method called the Bayer process. In a method for manufacturing aluminum hydroxide by the Bayer process, bauxite, which is a raw material for alumina, is mixed with a sodium hydroxide solution or a sodium aluminate solution in a high-temperature, high-pressure, and pressure-resistant container to extract an alumina content, and then the sodium aluminate solution obtained by removing red mud is cooled and a seed crystal of aluminum hydroxide is added, to thereby precipitate aluminum hydroxide.

In the Bayer process, aluminum hydroxide is precipitated by using a temperature difference. However, the rate of a precipitation reaction is slower than that in a case where aluminum hydroxide is obtained by using a neutralization reaction of acid and sodium aluminate, and thus the turnover rate of a manufacturing apparatus used in the Bayer process decreases, and hence productivity decreases. In the case of the manufacturing method by the Bayer process, in order to improve productivity, it is necessary to increase the size of the manufacturing apparatus such as a pressure-resistant container and to increase the temperature of the pressure-resistant container. Therefore, the Bayer process has a problem that all of costs, the amount of energy consumption, and an installation area of the manufacturing apparatus increase.

On the other hand, Patent Literature 1 discloses a method for purifying an aluminum hydroxide sludge as a method for obtaining aluminum hydroxide by using a neutralization reaction of acid and sodium aluminate. In the purification method disclosed in Patent Literature 1, an amorphous aluminum hydroxide sludge containing a toxic metal substance and a metal compound is dissolved in a caustic soda solution in which an alkali concentration has been adjusted, to thereby produce a sodium aluminate solution, and then the toxic metal substance and the metal compound are removed from the sodium aluminate solution by solid-liquid separation. Further, a solution obtained by removing the toxic metal substance and the metal compound from the sodium aluminate solution is neutralized to elute aluminum hydroxide, and the neutralized solution is subjected to solid-liquid separation, to thereby purify amorphous aluminum hydroxide.
[Patent Literature 1] Japanese Unexamined Patent Application Publication No. 2007-31245

### SUMMARY

Although aluminum hydroxide obtained as described above can be used as an industrial raw material, high purity may be required for aluminum hydroxide used as a raw material depending on the intended use. However, in the purification method disclosed in Patent Literature 1, there is a problem that since the solid-liquid separation by filtration is performed only once, impurities (toxic metal substances and metal compounds) cannot be sufficiently removed from the sodium aluminate solution, and hence a sufficient degree of purity of the obtained aluminum hydroxide may not be achieved.

The present disclosure has been made in order to solve such a problem, and an object thereof is to provide a method for manufacturing aluminum hydroxide by which it is possible to manufacture a high-purity aluminum hydroxide in which the number of impurities has been reduced.

A method for manufacturing aluminum hydroxide includes: a first neutralization process of adding, to a crude alkaline aluminate solution, an amount of substance of a first acid which neutralizes a part of alkali metal aluminate in the crude alkaline aluminate solution, thereby precipitating a precipitation containing aluminum hydroxide and impurities; a solid-liquid separation process of performing solid-liquid separation on a neutralization treatment solution obtained by the neutralization in the first neutralization process, thereby obtaining a purified alkaline aluminate solution from which the precipitation precipitated in the first neutralization process has been removed; a second neutralization process of adding, to the purified alkaline aluminate solution obtained in the solid-liquid separation process, a neutralization equivalent or more of a second acid which neutralizes a remainder of the alkali metal aluminate in the purified alkaline aluminate solution, thereby precipitating aluminum hydroxide; and an aluminum hydroxide recovery process of recovering the aluminum hydroxide precipitated in the second neutralization process.

According to the present disclosure, it is possible to provide a method for manufacturing aluminum hydroxide by which it is possible to manufacture a high-purity aluminum hydroxide in which the number of impurities has been reduced.

The above and other objects, features and advantages of the present disclosure will become more fully understood from the detailed description given hereinbelow and the accompanying drawings.

### BRIEF DESCRIPTION OF DRAWINGS

FIG. 1 is a schematic diagram showing a configuration of a manufacturing apparatus applied to a method for manufacturing aluminum hydroxide according to the present disclosure;

FIG. 2 is a flowchart showing an example of the method for manufacturing aluminum hydroxide according to the present disclosure;

FIG. 3 is a first graph showing results of elemental analysis performed on a first precipitation;

FIG. 4 is a second graph showing results of elemental analysis performed on the first precipitation;

FIG. 5 is a first graph showing results of elemental analysis performed on a second precipitation; and

FIG. 6 is a second graph showing results of elemental analysis performed on the second precipitation.

### DESCRIPTION OF EMBODIMENTS

### First Embodiment

Embodiments of the present disclosure will be described hereinafter with reference to the drawings. However, the present disclosure is not limited to the following embodiments. Further, for the clarification of the description, the following descriptions and drawings are simplified as appropriate.

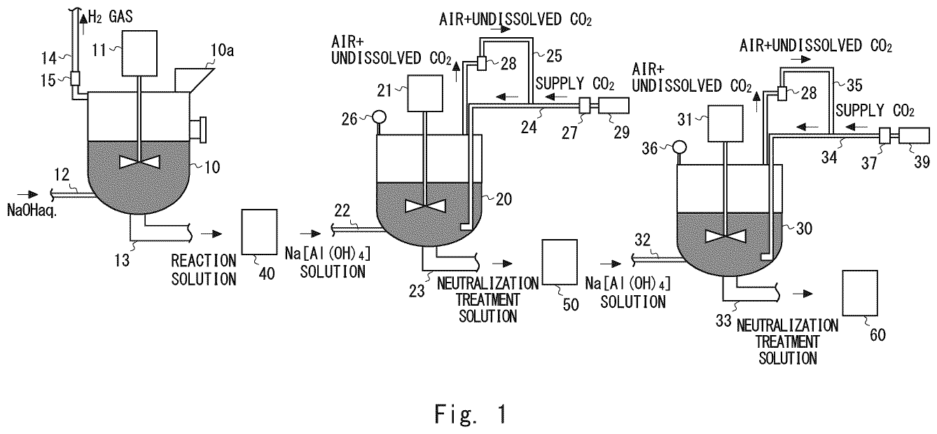

FIG. 1 is a schematic diagram showing a configuration of a manufacturing apparatus applied to a method for manufacturing aluminum hydroxide according to the present disclosure. The method for manufacturing aluminum hydroxide according to the present disclosure is performed by using, for example, a manufacturing apparatus 1 shown in FIG. 1. The manufacturing apparatus 1 shown in FIG. 1 includes a reaction tank 10, neutralization tanks 20 and 30, and solid-liquid separation apparatuses 40, 50, and 60.

The reaction tank 10 is of a hermetically closed type. An agitator 11, a liquid supply pipe 12, a liquid discharge pipe 13, an H₂ gas discharge pipe 14, and the like are provided in the reaction tank 10. A liquid level gauge that measures the liquid level of a liquid in the tank, a thermometer that measures the liquid temperature of a liquid in the tank, and a pressure gauge that measures the pressure in the tank may be provided in the reaction tank 10. An H₂ gas flowmeter 15 that measures the flow rate of hydrogen (H₂) gas flowing through the H₂ gas discharge pipe 14 is provided in the H₂ gas discharge pipe 14.

Each of the neutralization tanks 20 and 30 is of a hermetically closed type. Agitators 21 and 31, liquid supply pipes 22 and 32, liquid discharge pipes 23 and 33, CO₂ gas supply pipes 24 and 34, CO₂ gas circulation pipes 25 and 35, pressure gauges 26 and 36 that measure pressure in the tank, and the like are provided in the neutralization tanks 20 and 30. CO₂ gas flowmeters 27 and 37 that measure the flow rate of carbon dioxide (CO₂) gas flowing through the CO₂ gas supply pipes 24 and 34 are provided in the CO₂ gas supply pipes 24 and 34. CO₂ gas circulation pumps 28 and 38 that circulate carbon dioxide gas between the neutralization tanks 20 and 30 and the CO₂ gas supply pipes 24 and 34 are provided in the CO₂ gas circulation pipes 25 and 35. Carbon dioxide gas is supplied to the neutralization tanks 20 and 30 from CO₂ gas supply sources 29 and 39 through the CO₂ gas supply pipes 24 and 34. Further, the neutralization tanks 20 and 30 can exhaust residual pressure from the inside of the tank.

Examples of the solid-liquid separation apparatuses 40, 50, and 60 include a filter press, a Nutsch filter, and a centrifuge. A type of each of the solid-liquid separation apparatuses 40, 50, and 60 can be selected as appropriate in accordance with, for example, the property of a solution to be subjected to solid-liquid separation.

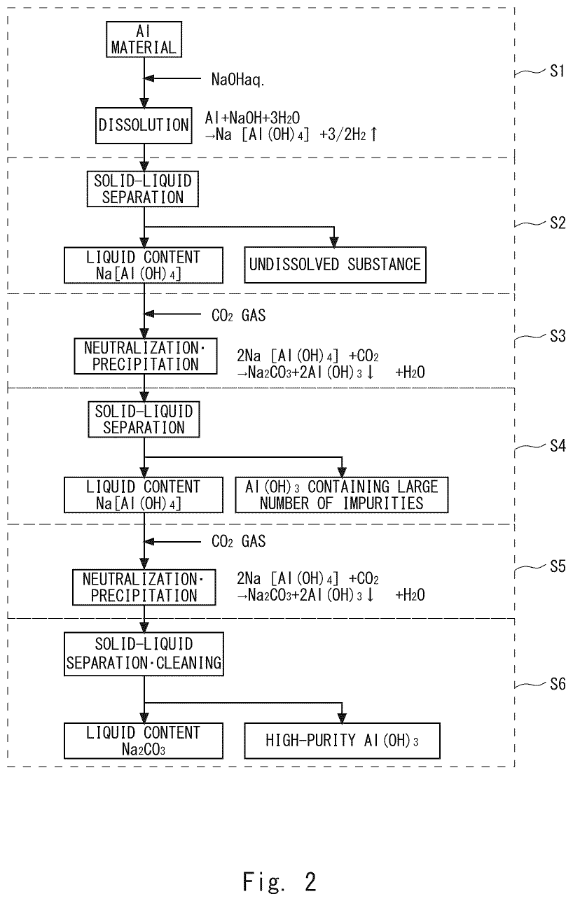

Next, FIG. 2 is a flowchart showing an example of the method for manufacturing aluminum hydroxide according to the present disclosure. In the method for manufacturing aluminum hydroxide (hereinafter may be simply referred to as a “manufacturing method”), aluminum hydroxide is manufactured from a used aluminum material as a raw material. According to the above manufacturing method, an aluminum material can be recycled.

As shown in FIG. 2, the manufacturing method according to the present disclosure includes processes of Steps S1 to S6. First, Step S1 is a dissolution process of dissolving an aluminum material (Al material) made of an aluminum alloy (Al alloy) by reacting it with a sodium hydroxide solution (NaOHaq.) which is an alkaline solution.

The reaction tank 10 can be used for the reaction. In the dissolution process, the aluminum material is charged through a charging port 10a into the reaction tank 10 holding the sodium hydroxide solution supplied through the liquid supply pipe 12, and the aluminum material is then immersed in the sodium hydroxide solution in the reaction tank 10.

The aluminum material is used as a raw material for manufacturing aluminum hydroxide. Examples of the aluminum material include scraps generated in the process of manufacturing aluminum products using aluminum alloys and waste discarded by factories such as chips. The aluminum material is not limited to waste discarded by factories, and may instead be, for example, waste discarded by markets such as aluminum cans and various packaging materials, or a material other than waste.

The aluminum material is made of an aluminum alloy. The aluminum alloy is an aluminum-based alloy which contains aluminum (Al) as a main component and one or more types of additive elements, which are elements other than aluminum. Examples of the additive elements include silicon (Si), copper (Cu), magnesium (Mg), zinc (Zn), iron (Fe), manganese (Mn), nickel (Ni), titanium (Ti), lead (Pb), and tin (Sn). These additive elements are added to aluminum in order to improve the strength and mechanical properties. Among the aluminum alloys, especially the aluminum alloy for die casting contains a large amount of additive elements. Therefore, the manufacturing method according to the present disclosure can be effectively used. Note that the aluminum alloy may contain unavoidable impurities in addition to aluminum and additive elements.

The sodium hydroxide solution is an aqueous solution obtained by dissolving sodium hydroxide (NaOH) in water such as pure water. In order to suitably dissolve the aluminum material, the sodium hydroxide solution is preferably an aqueous solution having a pH of 13 or higher. The concentration and the amount of usage of the sodium hydroxide solution are adjusted in accordance with the amount of aluminum in the aluminum material.

Note that, in the present disclosure, although a description is given of an example in which a sodium hydroxide solution is used as an alkaline solution, the alkaline solution is not limited to the sodium hydroxide solution as long as the aluminum material can be dissolved. As the alkaline solution, an aqueous solution of an alkaline substance such as a hydroxide of an alkali metal other than sodium hydroxide, an organic amine, and quaternary ammonium may be used. Examples of the hydroxide of an alkali metal other than sodium hydroxide include potassium hydroxide and lithium hydroxide. Examples of the organic amine include primary, secondary, and tertiary amines (specific examples include ethylamine, diethylamine, and triethylamine). Examples of the quaternary ammonium include tetramethylammonium hydroxide and tetraethylammonium hydroxide.

In the dissolution process, as shown in the following expression (1), the aluminum in the aluminum material is dissolved in the sodium hydroxide solution as sodium aluminate (Na[Al(OH)₄]), which is alkali metal aluminate, and hydrogen gas is generated.

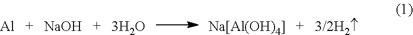

In a reaction solution obtained by reacting the aluminum material with the sodium hydroxide solution, not only the sodium aluminate is dissolved, but also additive elements derived from the aluminum alloy is contained in the form of a single-component metal, a hydroxide, an oxide, a salt or the like as impurities. Insoluble impurities are precipitated in the reaction solution as undissolved substances together with the undissolved aluminum. The undissolved substances are substances in the aluminum material which are not dissolved in the sodium hydroxide solution.

The sodium aluminate concentration of the reaction solution after the reaction is preferably adjusted by changing the amount of sodium hydroxide in the sodium hydroxide solution with which the aluminum material is made to react. By doing so, the sodium aluminate concentration of the reaction solution can be accurately adjusted while suppressing the influence of the variation in the amount of aluminum in the aluminum material. When the variation in the amount of aluminum in the aluminum material is small, the sodium aluminate concentration of the reaction solution after the reaction may be adjusted by changing the amount of usage of the aluminum material.

The end point of the reaction may be defined as a point in time when the amount of hydrogen gas generated by the reaction of the aluminum material and the sodium hydroxide solution is monitored and then the generation of the hydrogen gas stops. Note that the amount of generated hydrogen gas can be monitored by using the H₂ gas flowmeter 15.

The dissolution process preferably includes a hydrogen gas recovery process of recovering hydrogen gas generated by the reaction. The hydrogen gas generated in the reaction tank 10 is discharged from the reaction tank 10 through the H₂ gas discharge pipe 14 and stored, for example, in a hydrogen gas storage tank (not shown) provided outside the reaction tank 10. The obtained hydrogen gas can be used, for example, as an industrial raw material.

Step S2 is a preliminary solid-liquid separation process of performing solid-liquid separation on a reaction solution obtained in the dissolution process, thereby obtaining a separation solution from which undissolved substances have been removed.

The reaction solution after the reaction is discharged from the reaction tank 10 through the liquid discharge pipe 13 and then transferred to the solid-liquid separation apparatus 40. In the preliminary solid-liquid separation process, the reaction solution is charged into the solid-liquid separation apparatus 40 and separated into an undissolved substance, which is a solid content, and a separation solution, which is a liquid content, to obtain a separation solution from which undissolved substances have been removed.

Sodium aluminate is mainly dissolved in the separation solution from which undissolved substances have been removed, and soluble impurities are also dissolved. The separation solution is used as a crude sodium aluminate solution before neutralization in a first neutralization process described later. Note that it is preferable to recycle the removed undissolved substances since they may contain valuable metals.

Note that the aluminum alloy is obtained, for example, by cooling molten aluminum to which additive elements of various types are added and solidifying it. When the molten aluminum solidifies, at least some of the additive elements of various types dissolved in the molten aluminum form a very fine crystal structure. Therefore, when an aluminum material made of the aluminum alloy described above is dissolved in a sodium hydroxide solution, at least some of impurities may be dispersed in the reaction solution in the form of very fine particles. In this case, even if the reaction solution is subjected to solid-liquid separation, very fine impurities may remain in the crude sodium aluminate solution which is the separation solution.

In order to remove very fine impurities, it is conceivable to, for example, use a high-precision solid-liquid separation apparatus such as ultrafiltration apparatus. The use of such a high-precision solid-liquid separation apparatus, however, has a problem that the production cost increases.

However, if impurities cannot be sufficiently removed from the crude sodium aluminate solution, a sufficient degree of purity of the aluminum hydroxide obtained as a product may not be achieved. In order to address such problems, the manufacturing method according to the present disclosure enables impurities to be sufficiently removed from the crude sodium aluminate solution. Therefore, according to the manufacturing method according to the present disclosure, it is possible to manufacture a high-purity aluminum hydroxide in which the number of impurities has been reduced.

Step S3 is a first neutralization process of adding, to a crude sodium aluminate solution which is a crude alkaline aluminate solution, an amount of substance of carbon dioxide (CO₂) as a first acid which neutralizes a part of sodium aluminate in the crude sodium aluminate solution, thereby precipitating a precipitation containing aluminum hydroxide and impurities.

The crude sodium aluminate solution before neutralization is a separation solution obtained in the preliminary solid-liquid separation process. By using the separation solution as the crude sodium aluminate solution before neutralization, aluminum hydroxide having higher purity can be obtained as a product. Note that the crude sodium aluminate solution before neutralization to be used is not limited to the separation solution obtained in the preliminary solid-liquid separation process, and any crude sodium aluminate solution which is obtained by another method and in which aluminum hydroxide is precipitated by neutralization may instead be used.

The crude sodium aluminate solution before neutralization is preferably an aqueous solution having a pH of 12 to 14. In the first neutralization process, as shown in the following expression (2), carbon dioxide is dissolved in the crude sodium aluminate solution as sodium carbonate (Na₂CO₃), and aluminum hydroxide (Al(OH)₃) is precipitated and deposited.

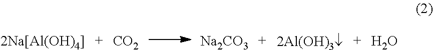

In the first neutralization process, as a method for adding carbon dioxide, a method for blowing carbon dioxide into the crude sodium aluminate solution in the form of carbon dioxide gas is preferably used. By doing so, solid-liquid separation after the first neutralization process can be easily performed.

The neutralization tank 20 can be used for neutralization. In the first neutralization process, carbon dioxide gas supplied from the CO₂ gas supply source 29 through the CO₂ gas supply pipe 24 is blown into the crude sodium aluminate solution supplied to the neutralization tank 20 through the liquid supply pipe 22 to neutralize a part of the sodium aluminate in the crude sodium aluminate solution held in the neutralization tank 20.

A part of the carbon dioxide gas blown into the crude sodium aluminate solution is not consumed in the neutralization reaction and diverges into a space formed in the upper part of the neutralization tank 20. The unreacted carbon dioxide gas diverged into the space is fed under pressure to the CO₂ gas supply pipe 24 through the CO₂ gas circulation pipe 25 from the inside of the neutralization tank 20 by the CO₂ gas circulation pump 28, and then blown into the crude sodium aluminate solution in the neutralization tank 20 again together with the carbon dioxide gas supplied from the CO₂ gas supply source 29.

Further, when the unreacted carbon dioxide gas diverges into the space, the pressure in the neutralization tank 20 increases. However, when the neutralization reaction is finished in response to the consumption of the total amount of the carbon dioxide gas blown into the solution, the pressure in the neutralization tank 20 returns to the pressure before the neutralization reaction.

Therefore, the end point of the neutralization reaction may be defined as a point in time when the pressure in the neutralization tank 20 during the neutralization reaction is monitored and then the pressure in the neutralization tank 20 returns to the pressure before the neutralization reaction. Note that the pressure in the neutralization tank 20 can be monitored by using the pressure gauge 26. Further, the blowing amount of carbon dioxide gas can be adjusted by using the CO₂ gas flowmeter 27.

Impurities precipitated together with aluminum hydroxide adhere to the aluminum hydroxide. Note that, in the first neutralization process, when carbon dioxide is added to the crude sodium aluminate solution, impurities precipitate in the form of hydroxide or carbonate together with aluminum hydroxide as the pH of the crude sodium aluminate solution decreases. However, due to the difference in solubility, impurities tend to precipitate before aluminum hydroxide precipitates. Then impurities precipitated in the form of hydroxide or carbonate form fine particles. Since these fine particles are very fine, it is difficult to remove them as fine particles by solid-liquid separation in the solid-liquid separation process. However, in the first neutralization process, aluminum hydroxide precipitates with these fine particles as nuclei, so that the particles of the precipitation are coarsened.

Further, among a small amount of impurities dissolved in the form of hydroxide in the crude sodium aluminate solution, some impurities are less soluble in carbonate than in hydroxide. Examples of such impurities include copper and zinc. Specifically, the solubility of copper (II) hydroxide is 0.29 mg/100 cm³, the solubility of basic copper (II) carbonate is 0.09 mg/cm³, the solubility of zinc hydroxide is 0.52 mg/100 cm³, and the solubility of zinc carbonate is 0.164 mg/100 cm³. Since the solubility of carbonate of each of the impurities described above is lower than that of aluminum hydroxide (10 mg/cm³), the precipitation of impurities is promoted in the initial stage of the neutralization reaction shown in the above expression (2).

If the amount of precipitation of aluminum hydroxide precipitated in the first neutralization process is too small, the efficiency of removing impurities decreases, whereas the yield of aluminum hydroxide obtained as a product increases. On the other hand, if the amount of precipitation of aluminum hydroxide precipitated in the first neutralization process is too large, the efficiency of removing impurities increases, whereas the yield of aluminum hydroxide obtained as a product decreases.

Therefore, the amount of substance of carbon dioxide which is the first acid is preferably 25% or more and 75% or less, more preferably 25% or more and 50% or less, and particularly preferably 30% or more and 50% or less, when the amount of substance of carbon dioxide by which all of the sodium aluminate in the crude sodium aluminate solution before neutralization can be neutralized is defined as 100%.

As a result, the yield can be improved while improving the purity of aluminum hydroxide obtained as a product. Note that the amount of substance of carbon dioxide which is the first acid can be determined based on the amount of aluminum in the aluminum material and the amount of sodium hydroxide in the sodium hydroxide solution with which the aluminum material is made to react.

Step S4 is a solid-liquid separation process of performing solid-liquid separation on a neutralization treatment solution obtained by the neutralization in the first neutralization process, thereby obtaining a purified sodium aluminate solution, which is a purified alkali aluminate solution from which the precipitation precipitated in the first neutralization process has been removed.

The neutralization treatment solution is discharged from the neutralization tank 20 through the liquid discharge pipe 23 and then transferred to the solid-liquid separation apparatus 50. In the solid-liquid separation process, the neutralization treatment solution is charged into the solid-liquid separation apparatus 50 and separated into a precipitation, which is a solid content, and a purified sodium aluminate solution, which is a liquid content, to obtain a purified sodium aluminate solution from which a precipitation has been removed.

The precipitation precipitated in the first neutralization process can be easily removed by solid-liquid separation using the solid-liquid separation apparatus 50 such as a filter press, a Nutsch filter, or a centrifuge since the particles thereof are coarsened as described above. Therefore, by adding a neutralization equivalent of carbon dioxide smaller than the neutralization equivalent by which all of the sodium aluminate in the crude sodium aluminate solution can be neutralized to the crude sodium aluminate solution and reacting it with the solution, and then performing solid-liquid separation on the resultant solution, impurities can be effectively removed while suppressing an increase in the production cost.

Step S5 is a second neutralization process of adding, to the purified sodium aluminate solution obtained in the solid-liquid separation process, a neutralization equivalent or more of carbon dioxide as a second acid which neutralizes the remainder of the sodium aluminate in the purified sodium aluminate solution, thereby precipitating aluminum hydroxide.

In the second neutralization process, as shown in the following expression (3), carbon dioxide is dissolved in the purified sodium aluminate solution as sodium carbonate (Na₂CO₃), and aluminum hydroxide (Al(OH)₃) is precipitated and deposited.

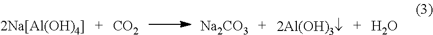

In the second neutralization process, as a method for adding carbon dioxide, a method for blowing carbon dioxide into the purified sodium aluminate solution in the form of carbon dioxide gas is preferably used. By doing so, solid-liquid separation after the second neutralization process can be easily performed.

However, in each of the first neutralization process and the second neutralization process, the method for adding carbon dioxide is not limited to the method for blowing carbon dioxide in the form of carbon dioxide gas, and may instead be another method such as a method for mixing carbon dioxide with a crude sodium aluminate solution or a purified sodium aluminate solution in the form of carbonated water.

Carbon dioxide is safer than other acids such as sulfuric acid, hydrochloric acid, and nitric acid, and a manufacturing apparatus made of a special material that can withstand these other acids is not required. Further, if carbon dioxide released into the atmosphere is used as at least one of the first acid and the second acid, the carbon dioxide can be captured as sodium carbonate after the reaction, and hence it is useful as a CO₂ fixation technique. Note that the first acid and the second acid are not limited to carbon dioxide, and may instead be other acids described above.

The neutralization tank 30 can be used for neutralization. In the second neutralization process, carbon dioxide gas supplied from the CO₂ gas supply source 39 through the CO₂ gas supply pipe 34 is blown into the purified sodium aluminate solution supplied to the neutralization tank 30 through the liquid supply pipe 32 to neutralize the remainder of the sodium aluminate in the purified sodium aluminate solution held in the neutralization tank 30.

In the second neutralization process, when carbon dioxide is added to the purified sodium aluminate solution, aluminum hydroxide precipitates as the pH of the purified sodium aluminate solution decreases. Since the purified sodium aluminate solution is highly purified, aluminum hydroxide precipitated from the purified sodium aluminate solution is extremely pure.

Further, the reaction expressed by each of the above expressions (2) and (3) is a neutralization reaction of an acid and an alkali, and the reaction proceeds instantaneously in one direction where the acid and the alkali react to form water (H₂O). Therefore, the reaction rate is overwhelmingly faster and the reaction efficiency is also higher than, for example, those in a crystallization method for precipitating aluminum hydroxide by adding a seed crystal of aluminum hydroxide to a supersaturated sodium aluminate solution. Thus, the time required for one manufacturing cycle can be shortened, and hence the size of the manufacturing apparatus 1 can be reduced.

In the second neutralization process, if carbon dioxide is excessively added to the purified sodium aluminate solution, the concentration of sodium hydrogencarbonate generated by the reaction of sodium carbonate, carbon dioxide, and water exceeds the solubility of sodium hydrogencarbonate, and the sodium hydrogencarbonate may precipitate and coprecipitate with aluminum hydroxide. Therefore, in order to suppress the deterioration of the purity of aluminum hydroxide that may occur when carbon dioxide is excessively added, the amount of substance of carbon dioxide which is the second acid is preferably closer to the above-described neutralization equivalent within a range in which the concentration of sodium hydrogencarbonate in the purified sodium aluminate solution does not exceed the solubility of sodium hydrogencarbonate.

Step S6 is an aluminum hydroxide recovery process of recovering the aluminum hydroxide precipitated in the second neutralization process.

In the neutralization treatment solution obtained by the neutralization in the second neutralization process, sodium carbonate is dissolved and aluminum hydroxide is precipitated. The neutralization treatment solution is discharged from the neutralization tank 30 through the liquid discharge pipe 33 and then transferred to the solid-liquid separation apparatus 60. In the aluminum hydroxide recovery process, the neutralization treatment solution is charged into the solid-liquid separation apparatus 60, and the neutralization treatment solution is separated into aluminum hydroxide, which is a solid content, and a sodium carbonate solution, which is a liquid content, to obtain aluminum hydroxide from which a sodium carbonate solution has been removed. Since sodium carbonate has a high degree of solubility in water, it is easily removed from aluminum hydroxide by solid-liquid separation.

Further, it is preferable to clean the obtained aluminum hydroxide with a cleaning solution. As the cleaning solution, water such as pure water can be used. By performing cleaning, the sodium carbonate solution remaining in the aluminum hydroxide can be removed. Further, in order to improve the efficiency of removing the sodium carbonate solution, the higher the temperature of the cleaning solution is within a range in which the heat-resistant temperature of a device such as a filter used for cleaning is not exceeded, the more preferable it is. For example, when a device made of polypropylene (PP) is used, the temperature of the cleaning solution is preferably a normal temperature or higher and 60° C. or lower.

By the above manufacturing method, a high-purity aluminum hydroxide can be obtained as a product. The obtained aluminum hydroxide can be used, for example, as an industrial raw material.

### EXAMPLES

The manufacturing method according to the present disclosure will be more specifically described hereinafter based on test examples. However, the present disclosure is not limited to these test examples.

Aluminum hydroxide was manufactured using an aluminum material as a raw material, and elemental analysis of each precipitation obtained during the manufacturing of the aluminum hydroxide was performed.

### Test Example 1

### [Dissolution Process]

As an aluminum material, chips of 1 to 2 mm generated in the process of manufacturing aluminum die-cast products using JIS ADC12 were prepared. As an alkaline solution, a sodium hydroxide solution of 4 wt % was prepared.

Note that the chemical components of JIS ADC12 are as follows.
Si: 9.6 to 12.0 wt %
Cu: 1.5 to 3.5 wt %
Mg: 0.3 wt % or less
Zn: 1.0 wt % or less
Fe: 1.3 wt % or less
Mn: 0.5 wt % or less
Ni: 0.5 wt % or less
Ti: 0.3 wt % or less
Pb: 0.2 wt % or less
Sn: 0.2 wt % or less
The remainder is Al

Next, 660 g of chips were charged into 20 L of a sodium hydroxide solution, and the chips was then immersed in the sodium hydroxide solution. In this way, chips were dissolved by reacting them with the sodium hydroxide solution.

### [Preliminary Solid-Liquid Separation Process]

A reaction solution after the reaction obtained by reacting the chips with the sodium hydroxide solution was filtered to obtain a separation solution from which undissolved substances have been removed as a crude sodium aluminate solution.

### [First Neutralization Process]

A part of sodium aluminate in the crude sodium aluminate solution was neutralized by blowing carbon dioxide gas into the crude sodium aluminate solution. By this neutralization, a precipitation containing aluminum hydroxide and impurities was precipitated. The amount of substance of the carbon dioxide gas used in the first neutralization process was 10% (i.e., 1.04 mol of the carbon dioxide gas) when 10.4 mol of the carbon dioxide gas was defined as 100%.

Note that the amount of substance of the carbon dioxide gas used in the first neutralization process can be determined as follows. First, since 20 L of a sodium hydroxide solution of 4 wt % was used in the dissolution process, the amount of the sodium hydroxide in the sodium hydroxide solution was 20.8 mol. Therefore, based on the expression (1), the amount of the sodium aluminate in the crude sodium aluminate solution before the neutralization was considered to be 20.8 mol. Then, based on the expression (2), 10.4 mol, which was ½ of the amount of substance of the sodium aluminate, was determined as the amount of substance of the carbon dioxide gas required to neutralize all of the sodium aluminate in the crude sodium aluminate solution before the neutralization.

### [Solid-Liquid Separation Process]

A neutralization treatment solution obtained by the neutralization in the first neutralization process was filtered to obtain a purified sodium aluminate solution from which the precipitation has been removed. In the following description, the precipitation separated by filtration in the solid-liquid separation process is referred to as a first precipitation.

### [Second Neutralization Process]

The remainder of the sodium aluminate in the purified sodium aluminate solution was neutralized by blowing a predetermined amount of carbon dioxide gas serving as the neutralization equivalent of carbon dioxide which neutralizes the remainder of the sodium aluminate into the purified sodium aluminate solution. By this neutralization reaction, a precipitation containing aluminum hydroxide was precipitated. The amount of substance of the carbon dioxide gas used in the second neutralization process was 90% (i.e., 9.36 mol of the carbon dioxide gas) when 10.4 mol of the carbon dioxide gas was defined as 100%.

Note that the amount of substance of the carbon dioxide gas used in the second neutralization process can be determined as follows. First, since 1.04 mol of the carbon dioxide gas was used in the first neutralization process, the remainder of the sodium aluminate in the purified sodium aluminate solution before the neutralization was considered to be 18.72 mol, which corresponds to 90% when 20.8 mol of the sodium aluminate was defined as 100%. Then, based on the expression (3), 9.36 mol, which was ½ of the amount of substance of the remainder of the sodium aluminate, was determined as the amount of substance of the carbon dioxide gas required to neutralize the remainder of the sodium aluminate in the purified sodium aluminate solution before the neutralization.

### [Aluminum Hydroxide Recovery Process]

A neutralization treatment solution obtained by the neutralization in the second neutralization process was filtered to obtain a precipitation from which the sodium carbonate solution has been removed. Further, the obtained precipitation was cleaned with pure water and then recovered as aluminum hydroxide. In the following description, the precipitation separated by filtration in the aluminum hydroxide recovery process is referred to as a second precipitation.

### Test Example 2

Aluminum hydroxide was obtained by a manufacturing method similar to that in Test Example 1, except that the ratio of the amount of substance of the carbon dioxide gas used in the first neutralization process was changed to 20% (i.e., 2.08 mol of the carbon dioxide gas), and the ratio of the amount of substance of the carbon dioxide gas used in the second neutralization process was changed to 80% (i.e., 8.32 mol of the carbon dioxide gas) accordingly.

### Test Example 3

Aluminum hydroxide was obtained by a manufacturing method similar to that in Test Example 1, except that the ratio of the amount of substance of the carbon dioxide gas used in the first neutralization process was changed to 30% (i.e., 3.12 mol of the carbon dioxide gas), and the ratio of the amount of substance of the carbon dioxide gas used in the second neutralization process was changed to 70% (i.e., 7.28 mol of the carbon dioxide gas) accordingly.

### Test Example 4

Aluminum hydroxide was obtained by a manufacturing method similar to that in Test Example 1, except that the ratio of the amount of substance of the carbon dioxide gas used in the first neutralization process was changed to 50% (i.e., 5.20 mol of the carbon dioxide gas), and the ratio of the amount of substance of the carbon dioxide gas used in the second neutralization process was changed to 50% (i.e., 5.20 mol of the carbon dioxide gas) accordingly.

### Test Example 5

Aluminum hydroxide was obtained by a manufacturing method similar to that in Test Example 1, except that the ratio of the amount of substance of the carbon dioxide gas used in the first neutralization process was changed to 70% (i.e., 7.28 mol of carbon dioxide gas), and the ratio of the amount of substance of the carbon dioxide gas used in the second neutralization process was changed to 30% (i.e., 3.12 mol of the carbon dioxide gas) accordingly.

### Test Example 6

Aluminum hydroxide was obtained by a manufacturing method similar to that in Test Example 1, except that the ratio of the amount of substance of the carbon dioxide gas used in the first neutralization process was changed to 90% (i.e., 9.36 mol of the carbon dioxide gas), and the ratio of the amount of substance of the carbon dioxide gas used in the second neutralization process was changed to 10% (i.e., 1.04 mol of the carbon dioxide gas) accordingly.

### Test Example 7

Aluminum hydroxide was obtained by a manufacturing method similar to that in Test Example 1, except that the ratio of the amount of substance of the carbon dioxide gas used in the first neutralization process was changed to 100% (i.e., 10.4 mol of the carbon dioxide gas), and the ratio of the amount of substance of the carbon dioxide gas used in the second neutralization process was changed to 0% (i.e., 0 mol of the carbon dioxide gas) accordingly.

### [Elemental Analysis]

For each of the first precipitations obtained in Test Examples 1 to 7, 100 g of the first precipitation that was cleaned with water was placed on an evaporation pan and evaporated to dryness in a dryer set at 200° C., to thereby prepare a sample for analysis. For each of the prepared samples, the evaporated-and-dried substance was ground in an agate mortar, and then elemental analysis was performed by a Scanning Electron Microscope-Energy Dispersive X-ray spectrometry (SEM-EDX). Table 1 shows the results.

TABLE 1

| | Test | Test | Test | Test | Test | Test | Test |
|---|---|---|---|---|---|---|---|
| | Example | Example | Example | Example | Example | Example | Example |
| | 1 | 2 | 3 | 4 | 5 | 6 | 7 |
| C | 2.05 | 2.56 | 2.93 | 2.06 | 1.72 | 2.95 | 2.14 |
| O | 38.51 | 37.89 | 37.95 | 50.00 | 44.45 | 41.19 | 36.16 |
| Na | 9.72 | 14.19 | 13.77 | 0.87 | 0.39 | 0.36 | 0.25 |
| Mg | 0.10 | 0.09 | 0.04 | 0.29 | 0.29 | 0.31 | 0.34 |
| Al | 26.41 | 23.76 | 23.72 | 45.62 | 50.62 | 52.06 | 59.39 |
| Si | 22.13 | 20.75 | 20.57 | 0.81 | 1.30 | 0.94 | 1.13 |
| P | 0.01 | 0.02 | 0.03 | 0.14 | 0.19 | 0.11 | 0.19 |
| S | 0.04 | 0.03 | 0.03 | 0.02 | 0.03 | 0.02 | 0.02 |
| Cl | 0.05 | 0.02 | 0.02 | 0.03 | 0.04 | 0.05 | 0.04 |
| Sn | 0.15 | 0.04 | 0.06 | 0.07 | 0.18 | 0.28 | 0.11 |
| Ca | 0.45 | 0.52 | 0.22 | 0.01 | 0.10 | 0.08 | 0.02 |
| Cr | 0.05 | 0.00 | 0.00 | 0.01 | 0.10 | 0.23 | 0.02 |
| Mn | 0.04 | 0.00 | 0.00 | 0.00 | 0.08 | 0.21 | 0.01 |
| Fe | 0.09 | 0.01 | 0.05 | 0.01 | 0.12 | 0.27 | 0.04 |
| Ni | 0.05 | 0.01 | 0.02 | 0.00 | 0.08 | 0.26 | 0.02 |
| Cu | 0.06 | 0.01 | 0.04 | 0.00 | 0.09 | 0.28 | 0.01 |
| Zn | 0.12 | 0.12 | 0.59 | 0.08 | 0.29 | 0.43 | 0.12 |
| Total | 100.00 | 100.00 | 100.00 | 100.00 | 100.00 | 100.01 | 100.00 |
| Al + O | 64.92 | 61.65 | 61.66 | 95.62 | 95.07 | 93.25 | 95.55 |
| C + Na | 11.77 | 16.74 | 16.69 | 2.93 | 2.11 | 3.31 | 2.39 |
| Others | 23.32 | 21.60 | 21.65 | 1.46 | 2.83 | 3.46 | 2.06 |

Further, for each of the second precipitations obtained in Test Examples 1 to 7, 100 g of the second precipitation that was cleaned with water was placed on an evaporation pan and evaporated to dryness in a dryer set at 200° C., to thereby prepare a sample for analysis. For each of the prepared samples, the evaporated-and-dried substance was ground in an agate mortar, and then elemental analysis was performed by SEM-EDX. Table 2 shows the results.

TABLE 2

| | Test | Test | Test | Test | Test | Test | Test |
|---|---|---|---|---|---|---|---|
| | Example | Example | Example | Example | Example | Example | Example |
| | 7 | 1 | 2 | 3 | 4 | 5 | 6 |
| C | 2.14 | 2.94 | 2.69 | 2.67 | 3.91 | 3.30 | 2.97 |
| O | 36.16 | 43.42 | 45.14 | 49.46 | 45.14 | 48.51 | 45.54 |
| Na | 0.25 | 0.24 | 0.23 | 0.51 | 0.34 | 0.42 | 0.30 |
| Mg | 0.34 | 0.29 | 0.28 | 0.30 | 0.31 | 0.29 | 0.31 |
| Al | 59.39 | 51.20 | 50.09 | 46.22 | 49.46 | 46.81 | 49.99 |
| Si | 1.13 | 1.17 | 1.13 | 0.62 | 0.68 | 0.48 | 0.46 |
| P | 0.19 | 0.24 | 0.25 | 0.17 | 0.18 | 0.14 | 0.24 |
| S | 0.02 | 0.02 | 0.01 | 0.01 | 0.00 | 0.01 | 0.02 |
| Cl | 0.04 | 0.03 | 0.02 | 0.02 | 0.00 | 0.02 | 0.04 |
| Sn | 0.11 | 0.06 | 0.05 | 0.03 | 0.00 | 0.03 | 0.10 |
| Ca | 0.02 | 0.02 | 0.02 | 0.00 | 0.00 | 0.00 | 0.01 |
| Cr | 0.02 | 0.03 | 0.00 | 0.00 | 0.00 | 0.00 | 0.00 |
| Mn | 0.01 | 0.04 | 0.00 | 0.00 | 0.00 | 0.00 | 0.00 |
| Fe | 0.04 | 0.07 | 0.01 | 0.00 | 0.00 | 0.00 | 0.00 |
| Ni | 0.02 | 0.05 | 0.00 | 0.00 | 0.00 | 0.00 | 0.00 |
| Cu | 0.01 | 0.05 | 0.00 | 0.00 | 0.00 | 0.00 | 0.00 |
| Zn | 0.12 | 0.16 | 0.08 | 0.00 | 0.00 | 0.00 | 0.00 |
| Total | 100.00 | 100.00 | 100.00 | 100.00 | 100.01 | 100.0 | 99.99 |
| Al + O | 95.55 | 94.62 | 95.24 | 95.67 | 94.60 | 95.33 | 95.53 |
| C + Na | 2.39 | 3.18 | 2.92 | 3.18 | 4.25 | 3.72 | 3.27 |
| Others | 2.06 | 2.20 | 1.85 | 1.14 | 1.16 | 0.96 | 1.19 |

### [Results]

According to the results of the elemental analysis shown in Table 2, the purity of the aluminum hydroxide obtained as a product in each of Test Examples 1 to 7 was as follows:
Test Example 1: 94.62%
Test Example 2: 95.24%
Test Example 3: 95.67%
Test Example 4: 94.60%
Test Example 5: 95.33%
Test Example 6: 95.53%
Test Example 7: 95.55%

It was found from the above results that a high-purity aluminum hydroxide in which the number of impurities has been reduced can be manufactured by the manufacturing method according to the present disclosure.

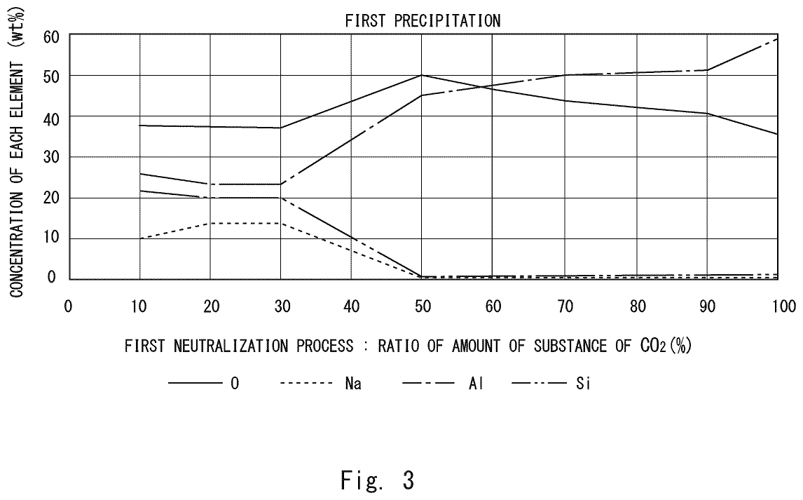

FIG. 3 is a first graph showing the results of the elemental analysis performed on the first precipitation. The vertical axis of the graph shown in FIG. 3 indicates the concentration (wt %) of each element (O, Na, Al, Si) in the sample prepared from the first precipitation. The horizontal axis of the graph shown in FIG. 3 indicates the ratio (%) of the amount of substance of the carbon dioxide gas used in the first neutralization process. Note that the ratio of the amount of substance of the carbon dioxide gas used in the first neutralization process is the ratio, expressed in a percentage, of the amount of substance of the carbon dioxide gas used in the first neutralization process to the amount of substance of the carbon dioxide gas by which all of the sodium aluminate in the crude sodium aluminate solution before the neutralization can be neutralized.

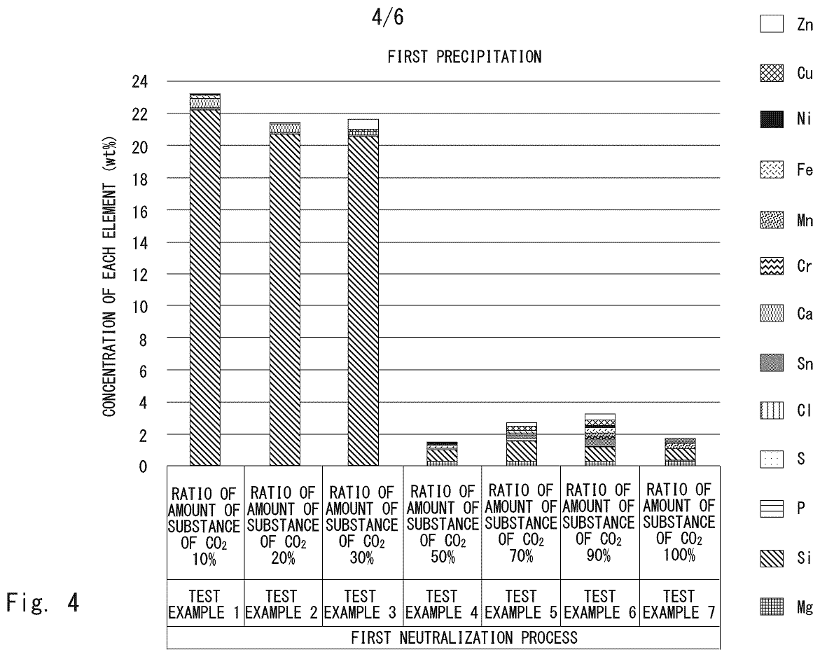

FIG. 4 is a second graph showing the results of the elemental analysis performed on the first precipitation. The graph in FIG. 4 shows the concentration (wt %) of impurities in the first precipitation for each Test Example.

As shown in each of the graphs of FIGS. 3 and 4, when the ratio of the amount of substance of the carbon dioxide gas used in the first neutralization process was 30% or less, it was found from the concentrations of Al and O that aluminum hydroxide was precipitated, and it was found from the concentrations of other elements that impurities mainly consisting of Si impurities were precipitated. Further, when the ratio of the amount of substance of the carbon dioxide gas used in the first neutralization process was 30% or less, it was found that impurities mainly consisting of Si impurities were actively precipitated. On the other hand, when the ratio of the amount of substance of the carbon dioxide gas used in the first neutralization process was more than 30%, it was found that the amount of precipitation of aluminum hydroxide rapidly increased since the concentrations of Al and O increased, and the amount of precipitation of Si impurities rapidly decreased since the concentrations of other elements decreased.

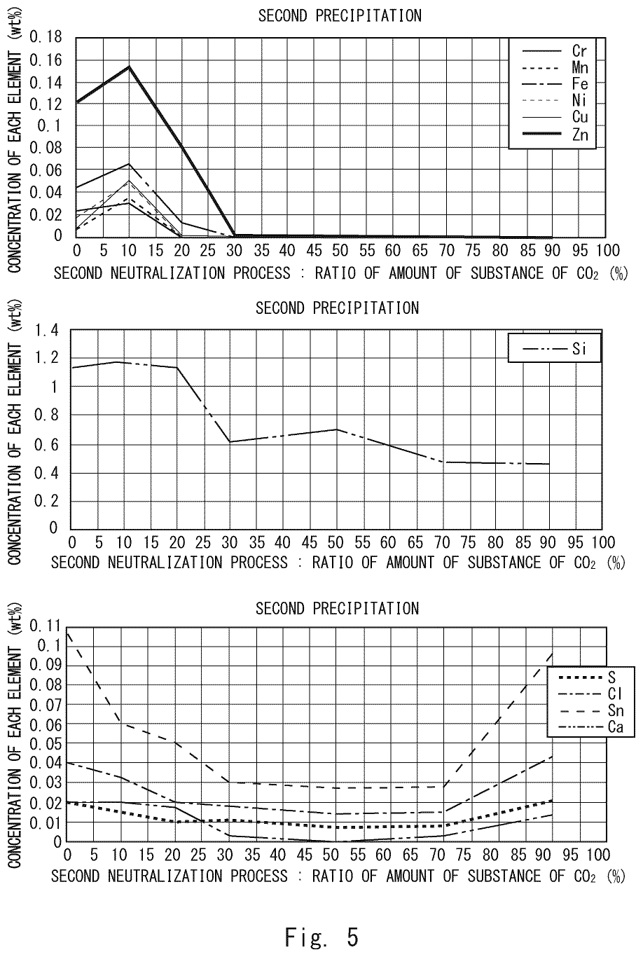

FIG. 5 is a first graph showing the results of the elemental analysis performed on the second precipitation. The vertical axis of the graph shown in FIG. 5 indicates the concentration (wt %) of each element (Cr, Mn, Fe, Ni, Cu, Zn, Si, S, Cl, Sn, Ca) in the sample prepared from the second precipitation. The horizontal axis of the graph shown in FIG. 5 indicates the ratio (%) of the amount of substance of the carbon dioxide gas used in the second neutralization process. Note that the ratio of the amount of substance of the carbon dioxide gas used in the second neutralization process is expressed in 100−(the ratio of the amount of substance of the carbon dioxide gas used in the first neutralization process).

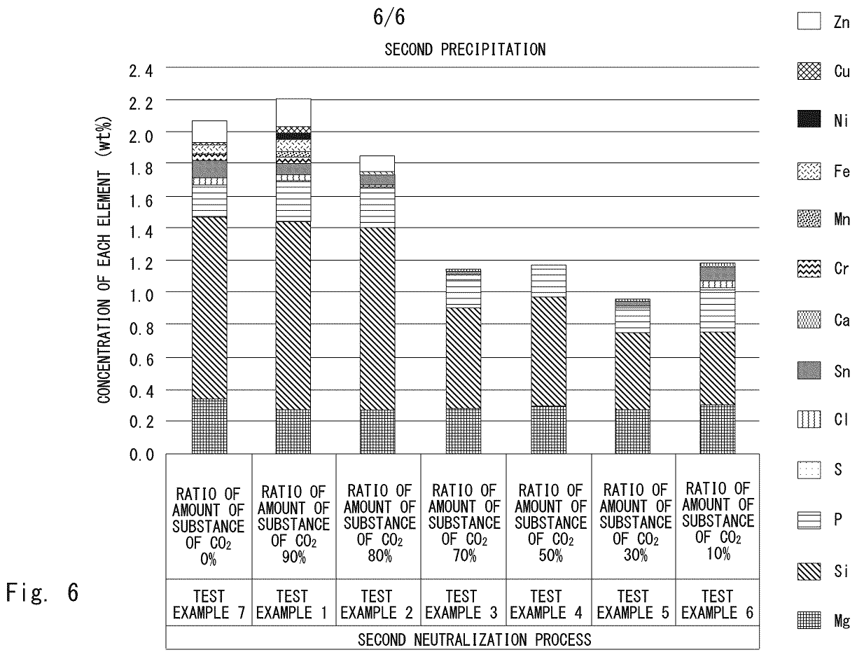

FIG. 6 is a second graph showing the results of the elemental analysis performed on the second precipitation. The graph in FIG. 6 shows the concentration (wt %) of impurities in the second precipitation for each Test Example.

As shown in each of the graphs of FIGS. 5 and 6, when the ratio of the amount of substance of the carbon dioxide gas used in the first neutralization process was less than 30% and the ratio of the amount of substance of the carbon dioxide gas used in the second neutralization process was more than 70%, it has been found from the concentrations of other elements that the amount of precipitation of impurities was substantially constant. On the other hand, when the ratio of the amount of substance of the carbon dioxide gas used in the first neutralization process was 30% or more and the ratio of the amount of substance of the carbon dioxide gas used in the second neutralization process was 70% or less, it has been found that the amount of precipitation of impurities remarkably decreased since the concentrations of other elements remarkably decreased.

Therefore, in order to improve the yield while improving the purity of aluminum hydroxide obtained as a product, a preferable range of the ratio of the amount of substance of the carbon dioxide gas used in the first neutralization process was determined to be 25% or more and 75% or less. However, when a higher priority is given to improving the purity of aluminum hydroxide obtained as a product, a preferable range is not limited to the above preferable range, and the higher the ratio of the amount of the carbon dioxide gas used in the first neutralization process, the more preferable it is.

Note that the present disclosure is not limited to the above-described embodiments and may be changed as appropriate without departing from the scope and sprit of the present disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A method for manufacturing aluminum hydroxide comprising:
a first neutralization process of adding, to a crude alkaline aluminate solution, an amount of substance of a first acid which neutralizes a part of alkali metal aluminate in the crude alkaline aluminate solution, thereby precipitating a precipitation containing aluminum hydroxide and impurities;
a solid-liquid separation process of performing solid-liquid separation on a neutralization treatment solution obtained by the neutralization in the first neutralization process, thereby obtaining a purified alkaline aluminate solution from which the precipitation precipitated in the first neutralization process has been removed;
a second neutralization process of adding, to the purified alkaline aluminate solution obtained in the solid-liquid separation process, a neutralization equivalent or more of a second acid which neutralizes a remainder of the alkali metal aluminate in the purified alkaline aluminate solution, thereby precipitating aluminum hydroxide; and
an aluminum hydroxide recovery process of recovering the aluminum hydroxide precipitated in the second neutralization process.

2. The method according to claim 1, wherein when the amount of substance of the first acid by which it is possible to neutralize all of the alkali metal aluminate in the crude alkaline aluminate solution before the neutralization is defined as 100%, the amount of substance of the first acid is 25% or more and 75% or less.

3. The method according to claim 1, wherein at least one of the first acid and the second acid is CO₂.

4. The method according to claim 1, comprising:
before the first neutralization process,
a dissolution process of dissolving an aluminum material made of an aluminum alloy by reacting the aluminum material with an alkaline solution; and
a preliminary solid-liquid separation process of performing solid-liquid separation on a reaction solution obtained in the dissolution process, thereby obtaining a separation solution from which an undissolved substance has been removed,
wherein the separation solution is used as the crude alkaline aluminate solution before the neutralization.

5. The method according to claim 4, wherein the dissolution process comprises a hydrogen gas recovery process of recovering hydrogen gas generated by the reaction.
